(19) United States
(12) Patent Application Publication
(10) Pub. No.: US 2024/0184439 A1
(43) Pub. Date: Jun. 6, 2024

(54) CROSS-CONTAINER CONTROL METHOD AND APPARATUS FOR COMPONENTS, AND ELECTRONIC DEVICE

(71) Applicant: Beijing Zitiao Network Technology Co., Ltd., Beijing (CN)

(72) Inventors: Yuhan ZHANG, Beijing (CN); Jing WANG, Beijing (CN); Ze ZHANG, Beijing (CN); Yu CHEN, Beijing (CN); Qiyang HUANG, Beijing (CN)

(21) Appl. No.: 18/569,090

(22) PCT Filed: Aug. 18, 2022
(86) PCT No.: PCT/CN2022/113408

§ 371 Date: Dec. 11, 2023

(30) Foreign Application Priority Data
Oct. 28, 2021 (CN) 202111265343.7

(51) Int. Cl. G06F 3/0486; G06F 3/04812

(52) U.S. Cl. CPC G06F 3/0486; G06F 3/04812

(57) ABSTRACT

The present invention relates to a multi-component cross-container control method, comprising: displaying an editor page, the editor page comprising a canvas area, and a plurality of components in a first container being displayed in the canvas area; and in response to a dragging input for at least two components in the plurality of components, when at least one component of the at least two components is overlapped with a second container, adding at least two components of target components into the second container, the second container being a sub-container or a parent container of the first container.

### CROSS-REFERENCE TO RELATED APPLICATION

The present disclosure claims the priority to Chinese Patent Application No. 202111265343.7, filed on Oct. 28, 2021, entitled “MULTI-COMPONENT CROSS-CONTAINER CONTROL METHOD AND APPARATUS, AND ELECTRONIC DEVICE,” the entire disclosure of which is incorporated herein by reference as portion of the present disclosure.

### TECHNICAL FIELD

The present disclosure relates to the technical field of software development, and in particular, to a cross-container control method and apparatus for a plurality of components, and an electronic device.

### BACKGROUND

Currently, in an operation activity, some display pages corresponding to the operation activity need to be designed, and these display pages will be edited and designed by an editor. Usually, there may be one or more containers in a page, and there may be one or more components in a container. Usually, each activity page needs to be edited and designed by the page editor. However, the editing and design process of the current display page is not sufficiently flexible.

### SUMMARY

In order to solve the above-mentioned technical problems or at least partially solve the above-mentioned technical problems, the present disclosure provides a cross-container control method and apparatus for a plurality of components, and an electronic device.

In order to realize the above-mentioned purposes, the embodiments of the present disclosure provide technical solutions as follows.

In a first aspect, a cross-container control method for a plurality of components is provided, including:
displaying an editor interface, in which the editor interface includes a canvas region, and a plurality of components in a first container are displayed in the canvas region;
and in response to a drag input for at least two components among the plurality of components, adding the at least two components into a second container in a case where at least one component among the at least two components overlaps with the second container, in which the second container is a sub-container or a parent container of the first container.

As an optional embodiment of the present disclosure, after displaying an editor interface and before in response to a drag input for at least two components among the plurality of components, the method further includes:
in response to a selection input for the at least two components, displaying a selection box for box selecting the at least two components, and displaying a selection cursor in the selection box;
and adding the at least two components into a second container in the case where at least one component among the at least two components overlaps with the second container, includes:
adding the at least two components into the second container in a case where at least one component among the at least two components overlaps with the second container and the selection cursor is in the second container.

As an optional embodiment of the present disclosure, the second container is a parent container of the first container, and the method further includes:
in response to the drag input for the at least two components, triggering to display a boundary of the second container in a response style in a case where a first condition is met;
and the first condition includes:
the selection cursor moves out of inside of the first container;
and/or at least one component among the at least two components moves to overlap with a boundary of the first container.

As an optional embodiment of the present disclosure, the second container is a parent container of the first container;
and before adding the at least two components into a second container in the case where at least one component among the at least two components overlaps with the second container, the method further includes:
moving at least one component among the at least two components to overlap with a boundary of the first container.

As an optional embodiment of the present disclosure, the second container is a sub-container of the first container, the at least two components and the second container are in a peering relationship, and the at least two components do not overlap with the second container; the method further includes:
in response to the drag input for the at least two components, triggering to display a boundary of the second container in a response style in a case where a second condition is met;
and the second condition includes:
the selection cursor moves to inside of the second container;
and/or at least one component among the at least two components moves to overlap with a boundary of the second container.

As an optional embodiment of the present disclosure, adding the at least two components into a second container in the case where at least one component among the at least two components overlaps with the second container, includes:
in a case where the at least two components both overlap with the second container, adding the at least two components into the second container in response to stopping the drag input.

In a second aspect, a cross-container control apparatus for a plurality of components is provided, including:
a display module, which is configured to display an editor interface, in which the editor interface includes a canvas region, and a plurality of components in a first container are displayed in the canvas region;
and a control module, which is configured to, in response to a drag input for at least two components among the plurality of components, add the at least two components into a second container in a case where at least one component among the at least two components overlaps with the second container, in which the second container is a sub-container or a parent container of the first container.

As an optional embodiment of the present disclosure, the control module is further configured to:
in response to a selection input for the at least two components, display a selection box for box selecting the at least two components, and display a selection cursor in the selection box;
and the control module is further configured to add the at least two components into the second container in a case where at least one component among the at least two components overlaps with the second container and the selection cursor is in the second container.

As an optional embodiment of the present disclosure, the second container is a parent container of the first container, and the control module is further configured to:
in response to the drag input for the at least two components, trigger to display a boundary of the second container in a response style in a case where a first condition is met;
the first condition includes:
the selection cursor moves out of inside of the first container;
and/or at least one component among the at least two components moves to overlap with a boundary of the first container.

As an optional embodiment of the present disclosure, the second container is a parent container of the first container;
and the control module is further configured to:
move at least one component among the at least two components to overlap with a boundary of the first container.

As an optional embodiment of the present disclosure, the second container is a sub-container of the first container, the at least two components and the second container are in a peering relationship, and the at least two components do not overlap with the second container; the control module is further configured to:
in response to the drag input for the at least two components, trigger to display a boundary of the second container in a response style in a case where a second condition is met;
and the second condition includes:
the selection cursor moves to inside of the second container;
and/or at least one component among the at least two components moves to overlap with a boundary of the second container.

As an optional embodiment of the present disclosure, the control module is further configured to:
in a case where the at least two components both overlap with the second container, add the at least two components into the second container in response to stopping the drag input.

In a third aspect, an electronic device is provided, including a processor, a memory, and a computer program that is stored in the memory and that can be run on the processor; and when the computer program is executed by the processor, the cross-container control method for a plurality of components according to any one of the embodiments in the first aspect is implemented.

In a fourth aspect, a computer-readable storage medium is provided, which stores a computer program, and when the computer program is executed by a processor, the cross-container control method for a plurality of components according to any one of the embodiments in the first aspect is implemented.

In a fifth aspect, a computer program product is provided, and when the computer program product is run on a computer, the computer is enabled to perform the cross-container control method for a plurality of components according to any one of the embodiments in the first aspect.

### BRIEF DESCRIPTION OF DRAWINGS

The drawings herein are incorporated into and form a part of the specification, illustrate the embodiments consistent with the present disclosure, and are used in conjunction with the specification to explain the principles of the present disclosure.

In order to more clearly illustrate the technical solutions in the embodiments of the present disclosure or in prior art, the drawings to be used in the description of the embodiments or prior art will be briefly described below, and it will be obvious to those ordinarily skilled in the art that other drawings can be obtained on the basis of these drawings without inventive work.

FIG. 1 is a schematic flowchart of a cross-container control method for a plurality of components according to at least one embodiment of the present disclosure;

FIG. 2 is a first schematic diagram of an editor interface according to at least one embodiment of the present disclosure;

FIG. 3 is a second schematic diagram of an editor interface according to at least one embodiment of the present disclosure;

FIG. 4 is a third schematic diagram of an editor interface according to at least one embodiment of the present disclosure;

FIG. 5 is a fourth schematic diagram of an editor interface according to at least one embodiment of the present disclosure;

FIG. 6 is a first schematic diagram of an editor interface during a drag input process according to at least one embodiment of the present disclosure;

FIG. 7 is a fifth schematic diagram of an editor interface according to at least one embodiment of the present disclosure;

FIG. 8 is a sixth schematic diagram of an editor interface according to at least one embodiment of the present disclosure;

FIG. 9 is a seventh schematic diagram of an editor interface according to at least one embodiment of the present disclosure;

FIG. 10 is an eighth schematic diagram of an editor interface according to at least one embodiment of the present disclosure;

FIG. 11 is a second schematic diagram of an editor interface during a drag input process according to at least one embodiment of the present disclosure;

FIG. 12 is a ninth schematic diagram of an editor interface according to at least one embodiment of the present disclosure;

FIG. 13 is a structural block diagram of a cross-container control apparatus for a plurality of components according to at least one embodiment of the present disclosure; and

FIG. 14 is a schematic diagram of a structure of an electronic device according to at least one embodiment of the present disclosure.

### DETAILED DESCRIPTION

In order to understand the above objects, features and advantages of the present disclosure more clearly, the solutions of the present disclosure will be further described below. It should be noted that, in case of no conflict, the features in one embodiment or in different embodiments can be combined.

Many specific details are set forth in the following description to fully understand the present disclosure, but the present disclosure can also be implemented in other ways different from those described here; obviously, the embodiments in the specification are a part but not all of the embodiments of the present disclosure.

Currently, in an operation activity, some display interfaces corresponding to the operation activity need to be designed, and these display interfaces will be edited and designed by an editor. Usually, there may be one or more containers in a interface, and there may be one or more components in a container. Usually, each activity interface needs to be edited and designed by the interface editor. In an editing process, components in a container can move within the container, but cannot implement cross-container movement. Therefore, the editing and design process of the current display interface is not sufficiently flexible.

To resolve the above-mentioned problem, the embodiments of the present disclosure provide a cross-container control method and apparatus for a plurality of components, and an electronic device, so that at least two components can perform cross-container movement (that is, from a first container to a second container). In this way, flexible interface editing may be implemented during the editing design process of a display interface in the editor interface (or editing interface).

The cross-container control method for a plurality of components provided in the embodiments of the present disclosure may be applied to a cross-container control apparatus for a plurality of components, or an electronic device. The cross-container control apparatus for a plurality of components may be a functional module or functional entity in the electronic device that can implement the cross-container control method for a plurality of components.

The embodiments of the present disclosure relate to the description that a component overlaps with a container. Overlapping herein may be understood as overlapping between the component and the container in boundary, and/or overlapping between the component and the container in area. Overlapping between the component and the container in boundary means that a boundary of the component overlaps with a boundary of the container, and overlapping between the component and the container in area means that the area of the component overlaps with the area of the container.

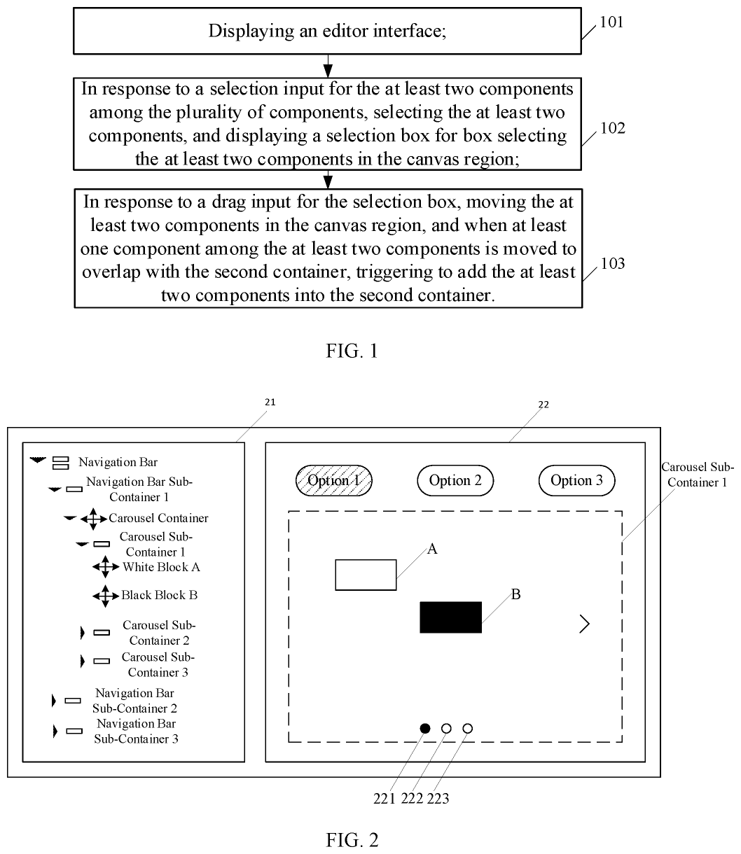

FIG. 1 is a schematic flowchart of a cross-container control method for a plurality of components, and the method includes the following steps.

Step 101: displaying an editor interface.

The editor interface includes a canvas region, and a plurality of components in a first container are displayed in the canvas region.

Further, the editor interface further includes a layer structure region. Layer positions of respective components and containers in the canvas region may be displayed in the layer structure region, and a canvas layout of respective components and containers may be displayed in the canvas region.

In the embodiments of the present disclosure, an option of the first container and an option of a second container, and options of a plurality of components under the option of the first container are displayed in the layer structure region. A canvas layout of the plurality of components is displayed in the canvas region, and the second container is a sub-container or a parent container of the first container.

FIG. 2 is a schematic diagram of an editor interface. The editor interface includes a layer structure region 21 and a canvas region 22. Options of a navigation bar in the layer structure region 21 includes options of three containers: a navigation bar sub-container 1, a navigation bar sub-container 2, and a navigation bar sub-container 3. The navigation bar sub-container 1 includes the following options of sub-containers: a carousel sub-container 1, a carousel sub-container 2, and a carousel sub-container 3. Options of two components exist under the carousel sub-container 1, and the two components are respectively a white block A and a black block B. A canvas layout of the two components is displayed in the canvas region 22. As shown in FIG. 2, in the canvas region, an option 1, an option 2, and an option 3 are used to identify the navigation bar sub-container 1, the navigation bar sub-container 2, and the navigation bar sub-container 3 respectively. The canvas region in FIG. 2 displays a canvas layout of the navigation bar sub-container 1 corresponding to the control option 1. Three options of the carousel sub-container 1, the carousel sub-container 2, and the carousel sub-container 3 may exist in a interface that corresponds to the navigation bar sub-container 1 and that is in the canvas region. A control 221, a control 222, and a control 223 are used to identify the carousel sub-container 1, the carousel sub-container 2, and the carousel sub-container 3 respectively. The canvas region shown in FIG. 2 displays the canvas layout in the carousel sub-container 1. The canvas layout of the white block A and the black block B in the carousel sub-container 1 can be seen.

Further, after the foregoing step 101, in response to a drag input for the at least two components among the plurality of components, the at least two components may be added into the second container in the case where at least one component among the at least two components overlaps with the second container. The second container is a sub-container or a parent container of the first container. In some embodiments, the process may be implemented through step 102 and step 103 below.

The drag input may be an input in which a target object (which may be a component in the embodiments of the present disclosure) is selected and dragged to a target region (position), and is released, and then the released target object is displayed at the target region (position). In an implementation process of the drag input, the component moves with the drag input, that is, the component moves from an initial position of the drag input all the way to an end position of the drag input. The initial position corresponds to a position of the component in the canvas region when drag starts, and the end position corresponds to a position of the component in the canvas region when drag stops. In other words, during the drag input process, a real-time position of the drag input is a real-time position corresponding to the component.

It should be noted that, in response to the drag input for the at least two components among the plurality of components, adding the at least two components into the second container in the case where the at least one component among the at least two components overlaps with the second container may include a plurality of cases.

For example, in response to the drag input for the at least two components among the plurality of components, in the case where the at least one component among the at least two components overlaps with the second container, the at least two components are both added into the second container regardless of whether the drag input stops.

For another example, in response to the drag input for the at least two components among the plurality of components, when the drag input stops, if the at least one component among the at least two components overlaps with the second container, the at least two components are added into the second container.

Step 102: in response to a selection input for the at least two components among the plurality of components, selecting the at least two components, and displaying a selection box for box selecting the at least two components in the canvas region.

The above-mentioned selection input for the at least two components among the plurality of components may be continuous click inputs for the at least two components by controlling a selection cursor by using a mouse by a user, or an input of selecting the at least two components by generating the selection box by controlling a mouse operation.

In some embodiments, in response to the selection input for the at least two components among the plurality of components, the at least two components are selected, the selection box for box selecting the at least two components is displayed in the canvas region, and the selection cursor is displayed in the selection box.

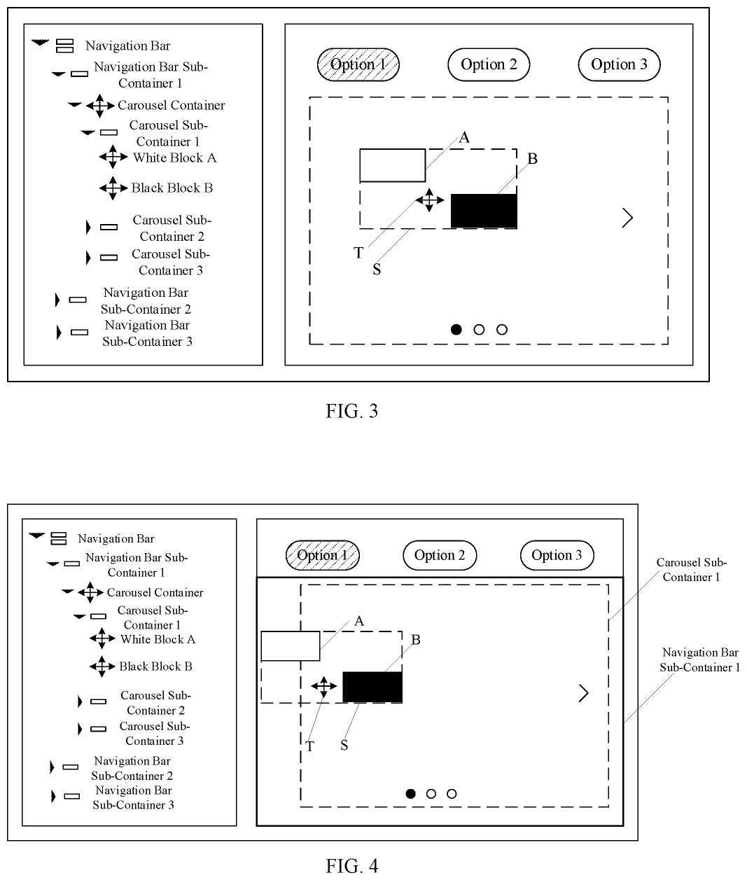

With reference to FIG. 2, when the user performs the selection input for the white block A and the black block B in the canvas region, the white block A and the black block B may be selected, and the selection box is displayed. In a schematic diagram of the editor interface shown in FIG. 3, a selection box S for box selecting the white block A and the black block B is displayed, and a selection cursor T is displayed in the selection box S.

Step 103: in response to a drag input for the selection box, moving the at least two components in the canvas region, and when at least one component among the at least two components is moved to overlap with the second container, triggering to add the at least two components into the second container.

In some embodiments, in response to the selection input for the at least two components, the selection cursor may be displayed in the selection box. Triggering to add the at least two components into the second container when at least one component among the at least two components is moved to overlap with the second container, includes: triggering to add the at least two components into the second container, that is, adding the at least two components into the second container when at least one component among the at least two components is moved to overlap with the second container and the selection cursor is in the second container.

In some embodiments of the present disclosure, adding the at least two components into the second container in the case where at least one component among the at least two components overlaps with the second container, includes: in the case where at least one component among the at least two components overlaps with the second container, adding the at least two components into the second container in response to stopping the drag input.

In some embodiments, when at least one component among the at least two components is moved to overlap with the second container, the at least two components are triggered to be added into the second container in response to stopping the drag input.

In some embodiments, triggering to add the at least two components into the second container when at least one component among the at least two components is moved to overlap with the second container, includes: triggering to add the at least two components into the second container when at least one component among the at least two components overlaps with the second container.

In some embodiments, triggering to add the at least two components into the second container when at least one component among the at least two components is moved to overlap with the second container, includes: triggering to add the at least two components into the second container when two or more components among the at least two components overlap with the second container.

In some embodiments, triggering to add the at least two components into the second container when at least one component among the at least two components is moved to overlap with the second container, includes: triggering to add the at least two components into the second container when the at least two components are both moved to overlap with the second container.

Further, in some embodiments, when the at least two components are both moved to overlap with the second container, the at least two components are triggered to be added into the second container in response to stopping the drag input.

Correspondingly, in the case where neither of the at least two components overlap with the second container, after the drag input stops, the at least two components are not added into the second container, and original positions remain unchanged.

According to the cross-container control method for a plurality of components provided by the embodiments of the present disclosure, in the editor interface, at least two components may be selected through the selection input for the at least two components of the first container, and the at least two components are controlled, through the drag input for the selection box of the at least two components, to move in the canvas region. When at least one component among the at least two components is moved to overlap with the second container, the at least two components may be triggered to move into the second container, so that the at least two components can perform cross-container movement (that is, from the first container to the second container). In this way, flexible interface editing can be implemented during the editing design process of a display interface in the editor interface.

In the embodiments of the present disclosure, the second container may be a parent container of the first container, or the second container may be a sub-container of the first container. The following will separately describe the two cases.

(Case 1) The second container is a parent container of the first container.

The method provided by the embodiments of the present disclosure further includes: in response to the drag input for the selection box, triggering to display a boundary of the second container in a response style in the case where a first condition is met.

In the embodiments of the present disclosure, the boundary of the second container may not be displayed in a non-response style, and the boundary of the second container is displayed in the response style; or the boundary of the second container is normally displayed in the non-response style, and the boundary of the second container is highlighted in the response style.

In the drawings involved in the embodiments of the present disclosure, for display of the boundary of the container, the non-response style is identified with a dotted line, and the response style is identified with a solid line.

The first condition includes at least one of the following (1) and (2):
(1) the selection cursor moves out of inside of the first container;
(2) at least one component among the at least two components moves to overlap with a boundary of the first container.

In some embodiments, the above-mentioned first condition may further include but is not limited to the following:
the selection box moves out of inside of the first container;
and the selection cursor moves to inside of the second container from outside of the second container.

It should be noted that, the above-mentioned descriptions of the first condition are merely exemplary descriptions, and in actual application, another condition for triggering to display the second container in the response style may also be set.

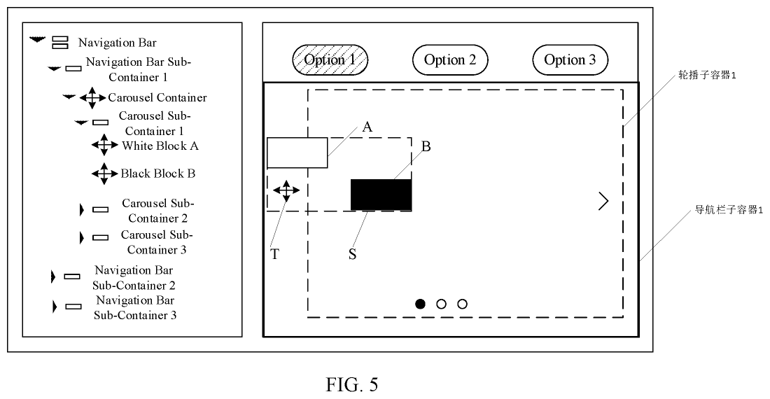

FIG. 4 is a schematic diagram of an editor interface. In FIG. 4, after the white block A and the black block B in the selection box S move, the white block A overlaps with the navigation bar sub-container 1, but the selection cursor T does not move out of inside of the first container, and the above-mentioned condition (2) is met. In this case, the carousel sub-container 1 may be displayed in the response style.

FIG. 5 is a schematic diagram of an editor interface. In FIG. 5, after the white block A and the black block B in the selection box S move, the white block A overlaps with the navigation bar sub-container 1, and the selection cursor T moves out of inside of the first container, and the above-mentioned conditions (1) and (2) are met. In this case, the carousel sub-container 1 may also be displayed in the response style.

In the above-mentioned embodiments, for drag of the selection box, when the components are dragged and are about to enter the second container, the second container is displayed in the response style, so that a user performing interface editing can be prompted that the components are about to enter the second container currently, to facilitate the user in observing the progress of the drag process.

In some embodiments, the second container is a parent container of the first container, and the method provided by the embodiments of the present disclosure includes: in response to the drag input for the selection box, at least two components move in the canvas region, and after at least one component among the at least two components moves to overlap with the boundary of the first container, the at least two components are triggered to be added into the second container when the at least one component among the at least two components moves to overlap with the second container.

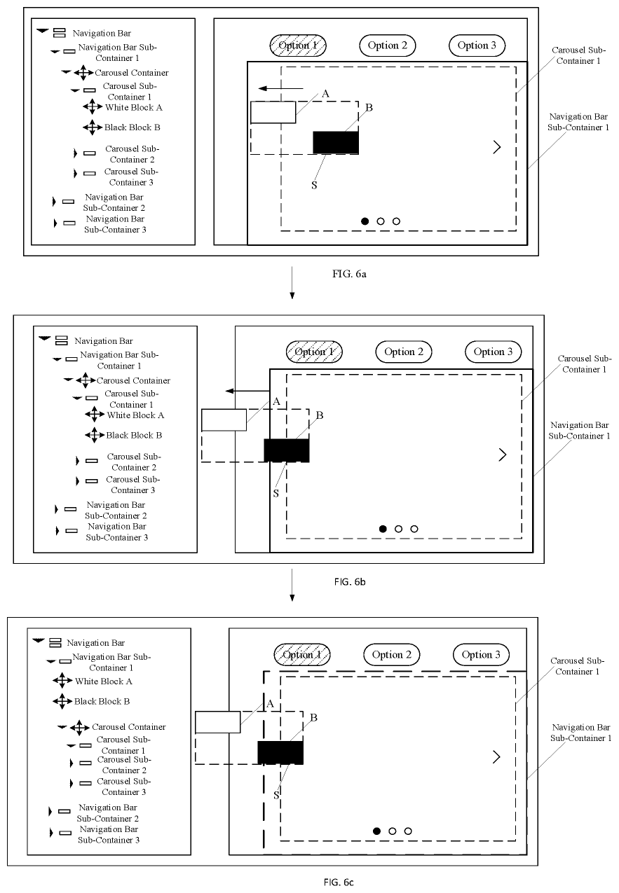

FIG. 6 is a schematic diagram of an editor interface during a drag input process. As shown in (a) in FIG. 6, in response to the drag input for the selection box S, the white block A and the black block B move in the canvas region, and the white block A moves to overlap with a boundary of the carousel sub-container 1. In this case, the navigation bar sub-container 1 in (a) in FIG. 6 is displayed in the response style. After the selection box S is further dragged in the direction shown by the arrow in the figure, as shown in (b) in FIG. 6, both the white block A and the black block B overlap with the second container. In this case, the white block A and the black block B may be triggered to be added into the navigation bar sub-container 1. After the white block A and the black block B are added into the navigation bar sub-container 1, as shown in (c) in FIG. 6, display of options of the white block A and the black block B under the option of the carousel sub-container 1 is canceled, and the options of the white block A and the black block B are added under the option of the navigation bar sub-container 1, and the navigation bar sub-container 1 switches to be displayed in the non-response style.

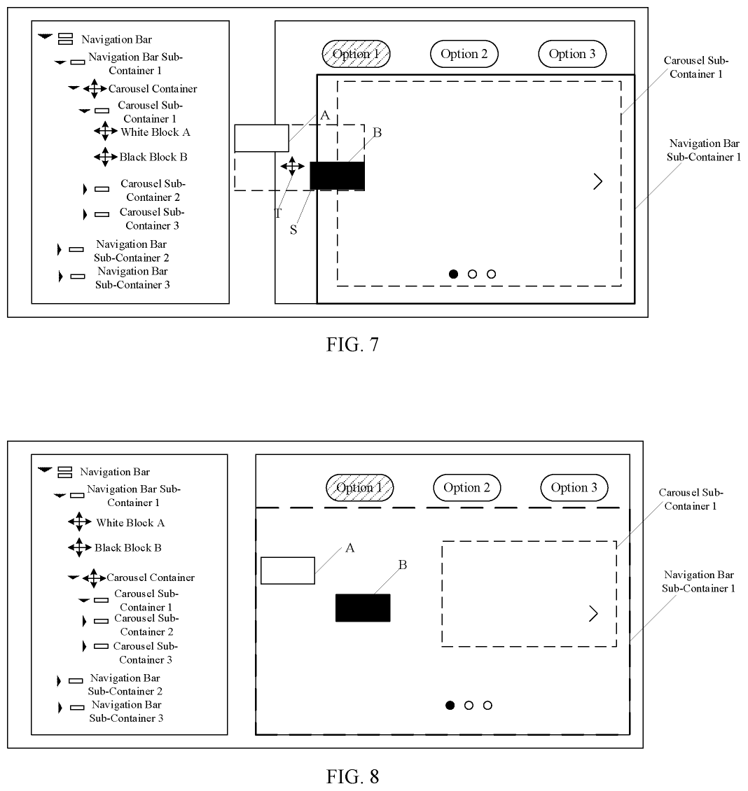

Further, as shown in FIG. 7, when both the white block A and the black box B overlap with the navigation bar sub-container 1, and the selection cursor T displayed in the selection box S of the white block A and the black box B is also in the navigation bar sub-container 1, in this case, the white block A and the black block B may be triggered to be added into the navigation bar sub-container 1.

(Case 2) The second container is a sub-container of the first container.

In the embodiments of the present disclosure, the at least two components and the second container are in a peering relationship, and the at least two components do not overlap with the second container in area.

For example, FIG. 8 is a schematic diagram of an editor interface. As shown in FIG. 8, the components: the white block A and the black block B are in a peering relationship with the carousel sub-container 1, the carousel sub-container 1 is a sub-container of the navigation bar sub-container 1, and neither the white block A nor the black block B overlaps with the carousel sub-container 1 in area.

The method provided by the embodiments of the present disclosure further includes: in response to the drag input for the selection box, triggering to display a boundary of the second container in a response style in the case where a second condition is met.

The above-mentioned second condition includes at least one of the following (3) and (4):
(3) the selection cursor moves to inside of the second container;
(4) at least one component among the at least two components moves to overlap with the boundary of the second container.

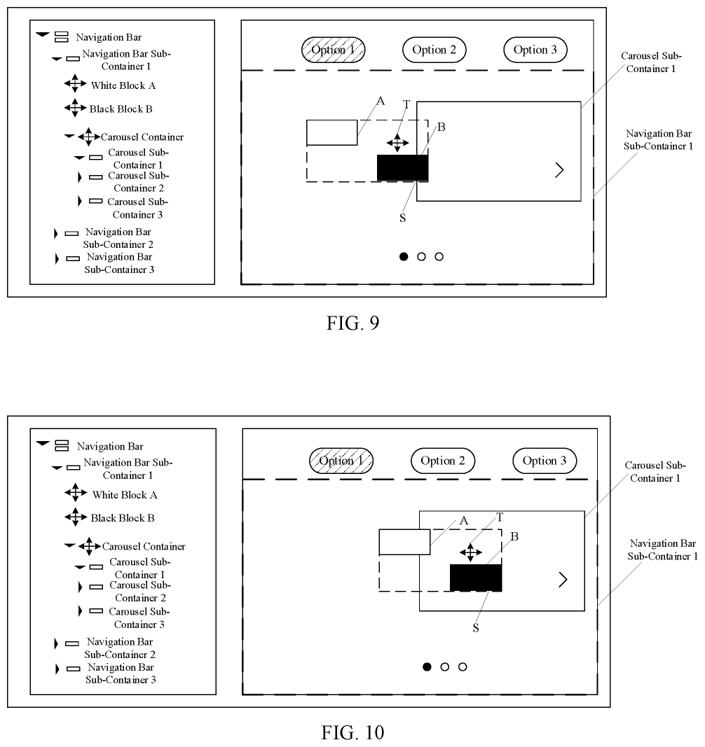

FIG. 9 is a schematic diagram of an editor interface. In FIG. 9, after the white block A and the black block B in the selection box S move, the black block B overlaps with the carousel sub-container 1, but the selection cursor T does not move to inside of the carousel sub-container 1, and the above-mentioned condition (4) is met. In this case, the carousel sub-container 1 may be displayed in the response style.

FIG. 10 is a schematic diagram of an editor interface. In FIG. 10, after the white block A and the black block B in the selection box S move, the black block B overlaps with the carousel sub-container 1, and the selection cursor T moves to inside of the carousel sub-container 1, and the above-mentioned conditions (3) and (4) are met. In this case, the carousel sub-container 1 may also be displayed in the response style.

In the above-mentioned embodiments, for drag of the selection box, when the components are dragged and are about to enter the second container, the second container is displayed in the response style, so that a user performing interface editing can be prompted that the components are about to enter the second container currently, to facilitate the user in observing the progress of the drag process.

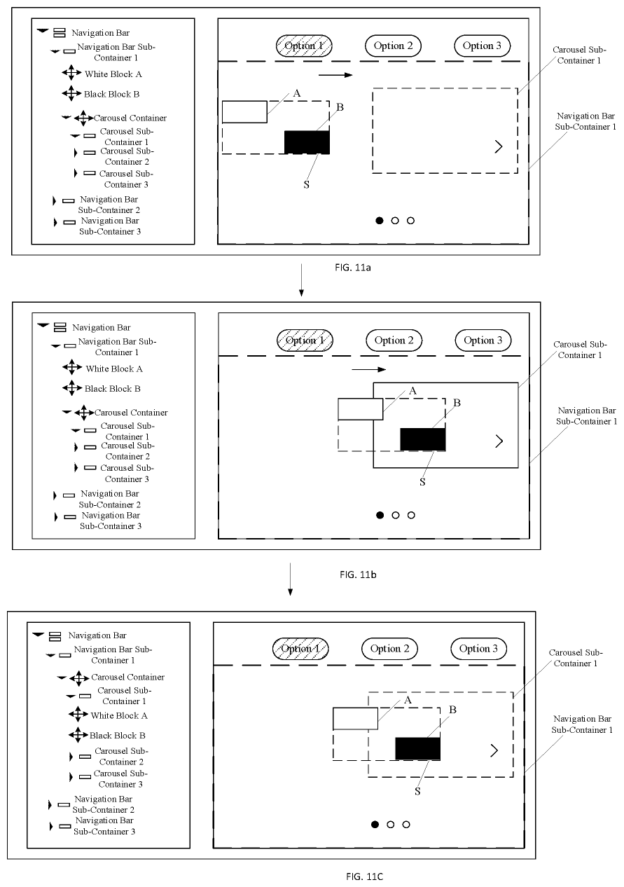

FIG. 11 is a schematic diagram of an editor interface during a drag input process. As shown in (a) in FIG. 11, in response to the drag input for the selection box S, the white block A and the black block B move in the canvas region, and the white block A and the black block B both move to overlap with the carousel sub-container 1. In this case, as shown in (b) in FIG. 11, the carousel sub-container 1 is displayed in the response style, and in this case, the white block A and the black block B may be triggered to be added into the carousel sub-container 1. After the white block A and the black block B are added into the carousel sub-container 1, as shown in (c) in FIG. 11, display of options of the white block A and the black block B under the option of the navigation bar sub-container 1 is canceled, and the options of the white block A and the black block B are added under the option of the carousel sub-container 1, and the carousel sub-container 1 switches to be displayed in the non-response style.

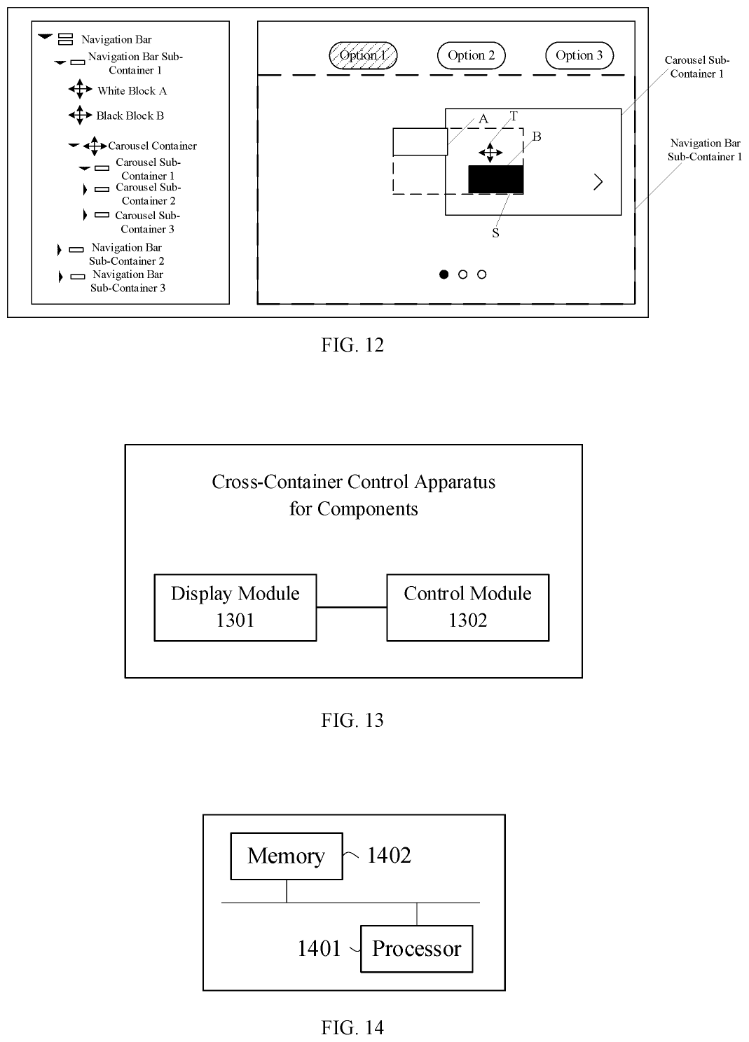

Further, as shown in FIG. 12, when both the white block A and the black box B overlap with the carousel sub-container 1, and the selection cursor T displayed in the selection box S of the white block A and the black box B is also in the carousel sub-container 1, in this case, the white block A and the black block B may be triggered to be added into the carousel sub-container 1.

After the above-mentioned step 103, a display manner for the layer structure region may include the following.

In an implementation, display of options of at least two components under the option of the first container is canceled, and the options of the at least two components are added under the option of the second container, as shown in (c) in FIG. 6, or in (c) in FIG. 11. Cross-container movement of the plurality of components is implemented in this implementation.

In another implementation, display of options of at least two components under the option of the first container is not canceled, and the options of the at least two components are added under the option of the second container, cross-container replication of the plurality of components is implemented in this implementation.

In the above-mentioned solution in the embodiments of the present disclosure, a scenario in which the components under the parent container move to the sub-container and a scenario in which the components under the sub-container move to the parent container are both described. The method provided by the embodiments of the present disclosure may be used in both scenarios, to implement cross-container movement of a plurality of components. In this way, during the editing design process of the display interface, flexible cross-container movement and replication of components can be performed for the two scenarios, to improve efficiency of the editing design process.

As shown in FIG. 13, a cross-container control apparatus for a plurality of components is provided, including:
a display module 1301, which is configured to display an editor interface, in which the editor interface includes a canvas region, and a plurality of components in a first container are displayed in the canvas region;
and a control module 1302, which is configured to, in response to a drag input for at least two components among the plurality of components, add the at least two components into a second container in the case where at least one component among the at least two components overlaps with the second container, in which the second container is a sub-container or a parent container of the first container.

In some implementations of the embodiments of the present disclosure, the control module 1302 is further configured to:
in response to a selection input for the at least two components, display a selection box for box selecting the at least two components, and display a selection cursor in the selection box;
and the control module 1302 is specifically configured to trigger to add the at least two components into the second container in the case where at least one component among the at least two components overlaps with the second container and the selection cursor is in the second container.

In some implementations of the embodiments of the present disclosure, the second container is a parent container of the first container, and the control module 1302 is further configured to:
in response to the drag input for the at least two components, trigger to display a boundary of the second container in a response style in the case where a first condition is met;
and the first condition includes:
the selection cursor moves out of inside of the first container;
and/or at least one component among the at least two components moves to overlap with a boundary of the first container.

In some implementations of the embodiments of the present disclosure, the second container is a parent container of the first container;
and the control module 1302 is further configured to:
move at least one component among the at least two components to overlap with a boundary of the first container.

In some implementations of the embodiments of the present disclosure, the second container is a sub-container of the first container, the at least two components and the second container are in a peering relationship, and the at least two components do not overlap with the second container in area, and the control module 1302 is further configured to:
in response to the drag input for the at least two components, trigger to display a boundary of the second container in a response style in the case where a second condition is met;
and the second condition includes:
the selection cursor moves to inside of the second container;
and/or at least one component among the at least two components moves to overlap with a boundary of the second container.

In some implementations of the embodiments of the present disclosure, the control module 1302 is specifically configured to:
in the case where at least one component among the at least two components overlaps with the second container, add the at least two components into the second container in response to stopping the drag input.

In some implementations of the embodiments of the present disclosure, the control module 1302 is specifically configured to:
in the case where the at least two components both overlap with the second container, add the at least two components into the second container in response to stopping the drag input.

As shown in FIG. 14, the embodiments of the present disclosure further provide an electronic device, including a processor 1401, a memory 1402, and a computer program that is stored in the memory 1402 and that can be run on the processor 1401. When the computer program is executed by the processor 1401, the cross-container control method for a plurality of components in the method embodiments is implemented.

The embodiments of the present disclosure further provide a computer-readable storage medium, the computer-readable storage medium stores a computer program, and when the computer program is executed by a processor, the cross-container control method for a plurality of components in the method embodiments is implemented.

The embodiments of the present disclosure further provide a computer program product, and when the computer program product is run on a computer, the computer is enabled to perform the cross-container control method for a plurality of components in the method embodiments.

The person skilled in the art should understand that the embodiments of the present disclosure may be provided as a method, a system, or a computer program product. Therefore, the present disclosure may use a form of hardware only embodiments, software only embodiments, or embodiments with a combination of software and hardware. In addition, the present disclosure may use a form of a computer program product that is implemented on one or more computer-usable storage media that include computer-usable program code.

In the present disclosure, the processor may be a Central Processing Unit (CPU), or may be another general-purpose processor, a Digital Signal Processor (DSP), an Application Specific Integrated Circuit (ASIC), a Field-programmable Gate Array (FPGA) or another programmable logic device, a discrete gate or transistor logic device, or a discrete hardware component. The general-purpose processor may be a microprocessor, or the processor may be any conventional processor or the like.

In the present disclosure, the memory may include a non-permanent memory, a random access memory (RAM) and/or a non-volatile memory in a computer-readable medium, for example, a read-only memory (ROM) or a flash RAM. The memory is an example of the computer-readable medium.

In the present disclosure, the computer-readable storage media include permanent and non-permanent, removable and non-removable storage media. The storage medium may store information by using any method or technology. The information may be a computer-readable instruction, a data structure, a program module, or other data. Examples of the storage medium of a computer include, but are not limited to, a Phase-Change Random Access Memory (PRAM), a Static Random Access Memory (SRAM), a Dynamic Random Access Memory (DRAM), another type of Random Access Memory (RAM), a Read-Only Memory (ROM), an Electrically Erasable Programmable Read-Only Memory (EEPROM), a flash memory or another memory technology, a Compact Disc Read-Only Memory (CD-ROM), a Digital Versatile Disk (DVD) or another optical storage, a magnetic cartridge tape, a magnetic disk storage or another magnetic storage device or any other non-transmission medium that can be used to store information that can be accessed by a computing device. As defined herein, a computer-readable medium does not include transitory computer-readable media, such as modulated data signals and carriers.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The above descriptions are only specific embodiments of the present disclosure, enabling those skilled in the art to understand or implement the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments described herein but is to be accorded the widest scope consistent with the principles and novel features disclosed herein.

1. A cross-container control method for a plurality of components, comprising:
displaying an editing interface, wherein the editing interface comprises a canvas region, and a plurality of components in a first container are displayed in the canvas region; and
in response to a drag input for at least two components among the plurality of components, adding the at least two components into a second container in a case where at least one component among the at least two components overlaps with the second container, wherein the second container is a sub-container or a parent container of the first container.

2. The method according to claim 1, wherein after displaying an editing interface and before in response to a drag input for at least two components among the plurality of components, the method further comprises:
in response to a selection input for the at least two components, displaying a selection box for box selecting the at least two components, and displaying a selection cursor in the selection box; and
adding the at least two components into a second container in the case where at least one component among the at least two components overlaps with the second container, comprises:
adding the at least two components into the second container in a case where at least one component among the at least two components overlaps with the second container and the selection cursor is in the second container.

3. The method according to claim 2, wherein the second container is a parent container of the first container, and the method further comprises:
in response to the drag input for the at least two components, triggering to display a boundary of the second container in a response style in a case where a first condition is met; and
the first condition comprises:
the selection cursor moves out of inside of the first container; and/or
at least one component among the at least two components moves to overlap with a boundary of the first container.

4. The method according to claim 1, wherein the second container is a parent container of the first container, and
before adding the at least two components into a second container in the case where at least one component among the at least two components overlaps with the second container, the method further comprises:
moving at least one component among the at least two components to overlap with a boundary of the first container.

5. The method according to claim 2, wherein the second container is a sub-container of the first container, the at least two components and the second container are in a peering relationship, and the at least two components do not overlap with the second container;
the method further comprises:
in response to the drag input for the at least two components, triggering to display a boundary of the second container in a response style in a case where a second condition is met; and
the second condition comprises:
the selection cursor moves to inside of the second container; and/or
at least one component among the at least two components moves to overlap with a boundary of the second container.

6. The method according to claim 1, wherein adding the at least two components into a second container in the case where at least one component among the at least two components overlaps with the second container, comprises:
in the case where at least one component among the at least two components overlaps with the second container, adding the at least two components into the second container in response to stopping the drag input.

7. The method according to claim 6, wherein adding the at least two components into a second container in the case where at least one component among the at least two components overlaps with the second container, comprises:
in a case where the at least two components both overlap with the second container, adding the at least two components into the second container in response to stopping the drag input.

8. A cross-container control apparatus for a plurality of components, comprising:
a display module, configured to display an editing interface, wherein the editing interface comprises a canvas region, and a plurality of components in a first container are displayed in the canvas region; and
a control module, configured to, in response to a drag input for at least two components among the plurality of components, add the at least two components into a second container in a case where at least one component among the at least two components overlaps with the second container, wherein the second container is a sub-container or a parent container of the first container.

9. An electronic device, comprising a processor, a memory, and a computer program that is stored in the memory and that can be run on the processor, wherein when the computer program is executed by the processor, the cross-container control method for a plurality of components according to claim 1 is implemented.

10. A computer-readable storage medium, storing a computer program, wherein when the computer program is executed by a processor, the cross-container control method for a plurality of components according to claim 1 is implemented.

11. (canceled)

12. The apparatus according to claim 8, wherein the control module is further configured to, in response to a selection input for the at least two components, display a selection box for box selecting the at least two components, and display a selection cursor in the selection box; and
the control module is further configured to add the at least two components into the second container in a case where at least one component among the at least two components overlaps with the second container and the selection cursor is in the second container.

13. The apparatus according to claim 12, wherein the second container is a parent container of the first container;
the control module is further configured to, in response to the drag input for the at least two components, trigger to display a boundary of the second container in a response style in a case where a first condition is met; and
the first condition comprises:
the selection cursor moves out of inside of the first container; and/or
at least one component among the at least two components moves to overlap with a boundary of the first container.

14. The apparatus according to claim 8, wherein the second container is a parent container of the first container, and
the control module is further configured to move at least one component among the at least two components to overlap with a boundary of the first container.

15. The apparatus according to claim 12, wherein the second container is a sub-container of the first container, the at least two components and the second container are in a peering relationship, and the at least two components do not overlap with the second container;
the control module is further configured to, in response to the drag input for the at least two components, trigger to display a boundary of the second container in a response style in a case where a second condition is met; and
the second condition comprises:
the selection cursor moves to inside of the second container; and/or
at least one component among the at least two components moves to overlap with a boundary of the second container.

16. The apparatus according to claim 8, wherein the control module is further configured to, in the case where at least one component among the at least two components overlaps with the second container, add the at least two components into the second container in response to stopping the drag input.

17. The apparatus according to claim 16, wherein the control module is further configured to, in a case where the at least two components both overlap with the second container, add the at least two components into the second container in response to stopping the drag input.

18. An electronic device, comprising a processor, a memory, and a computer program that is stored in the memory and that can be run on the processor, wherein when the computer program is executed by the processor, the cross-container control method for a plurality of components according to claim 3 is implemented.

19. An electronic device, comprising a processor, a memory, and a computer program that is stored in the memory and that can be run on the processor, wherein when the computer program is executed by the processor, the cross-container control method for a plurality of components according to claim 6 is implemented.

20. A computer-readable storage medium, storing a computer program, wherein when the computer program is executed by a processor, the cross-container control method for a plurality of components according to claim 3 is implemented.

21. A computer-readable storage medium, storing a computer program, wherein when the computer program is executed by a processor, the cross-container control method for a plurality of components according to claim 6 is implemented.
